(19) United States
(12) Patent Application Publication
(10) Pub. No.: US 2009/0271476 A1
(43) Pub. Date: Oct. 29, 2009

(54) METHOD FOR REDUCING TRANSMITTED DATA

(75) Inventor: Kjell Sundby, Horten (NO)

Correspondence Address: BIRCH STEWART KOLASCH & BIRCH, PO BOX 747, FALLS CHURCH, VA, 22040-0747, US

(73) Assignee: Virtek Communication AS, Horten (NO)

(21) Appl. No.: 12/301,755

(22) PCT Filed: May 22, 2007
(86) PCT No.: PCT/NO07/00178

§ 371 Date: Feb. 3, 2009

(30) Foreign Application Priority Data
May 22, 2006 (NO) 2006 2320

(51) Int. Cl. G06F 15/16

(52) U.S. Cl. 709/203; 709/201

(57) ABSTRACT

Red Line is an extension of a traditional web proxy for reducing the transmitted amount of data to an end user while also giving said user the opportunity of retrieving an original without damaging the original shape of a web page.

The invention, referred to as RedLine, is used for transmission of web objects across TCP/IP based transport lines.

Frequently the objects are transmitted to users in full quality without said users gain anything particular by this. Frequently said objects can be advertising, pictures for navigation or pictures of an event.

The basis in the known art is known as “web proxy”, cf.: RFC 1945, that additionally is able to remove unwanted objects from a transmitted web page. Up to now said methods have frequently damaged contents and damaged the looks completely and are for that reason not particular useful for ordinary use.

RedLine overcomes these problems and replaces removed objects with a reduced version in such a way that the structure of said web pages remain identical to the original. Said reduced objects comprise an inserted field, in the form of a red line, which is the characteristics of the object being presented in a reduced quality. When the user activates said red line, said reduced object will be replaced with said original.

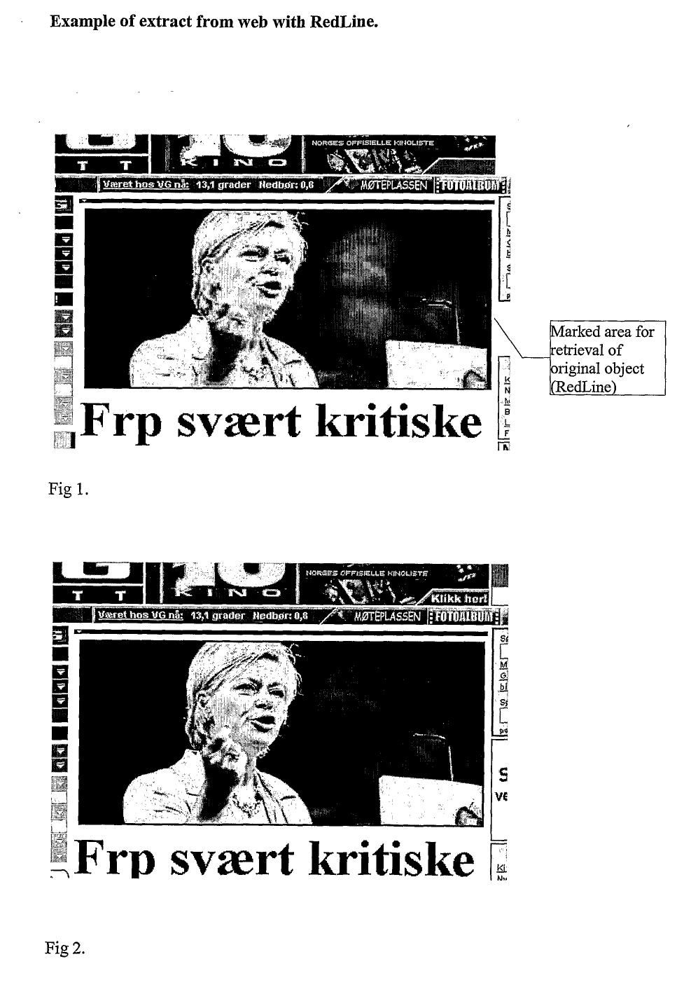

FIG. 1 shows a part of web page comprising a picture with reduced quality and red line (3.7 KByte).

FIG. 2 shows the same part after the using having activated the red line (14 KByte).

When the user of a web client activates said red line the request is issued and said original picture is retrieved. This can be performed for all objects of all kinds such as pictures and advertising.

1. Method for reducing transmitted data, characterised by:
initially transmitting a compound document comprising one or more objects from a proxy, said proxy retrieving an original document from a second server,
transmitting an indicator for each object along with an activation symbol for each object from the proxy server,
wherein said indication is a visual representation comprising a lesser amount of data than said original,
wherein said compound document is generally the same as said original document from the second server.

2. Method according to claim 1, characterised by retrieving said original for said visual representation from said proxy server on activating said activation symbol, wherein said original is inserted into said compound document in place of said indication and said activation symbol.

3. Proxy server for reducing transmitted data, characterised by:
means for receiving a request from a client,
means for passing on said-request to a second server,
means for retrieving an original document and optional objects belonging to said document from said second server,
means for transmitting to said client, said document and a visual representation for each object, wherein said visual representation comprise a lesser amount of data than said original and an activation symbol for each object,
means for transmitting to said client an original object when said client transmit a request from said activation symbol for a corresponding visual representation.
